(19) United States
(12) Patent Application Publication
(10) Pub. No.: US 2010/0109606 A1
(43) Pub. Date: May 6, 2010

(54) CHARGING CONTROL CIRCUIT

(75) Inventors: Chia-Han Chan, Taipei Hsien (TW); Nan-Sheng Chang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/263,088

(22) Filed: Oct. 31, 2008

(51) Int. Cl. H02J 7/00

(52) U.S. Cl. 320/116

(57) ABSTRACT

A charging control circuit connected with a charging power supply for charging a pile formed by a series-connection of battery units includes a protecting circuit having control ports and monitoring ports, a charging circuit including diffluent circuits respectively parallel-connected to the corresponding battery units, and a control circuit including two parallel branches connected between the charging power supply and the pile. The monitoring ports are connected to two terminals of the corresponding battery units. Each diffluent circuit has a controlled switch element and a diffluent resistance element series-connected with each other. The controlled switch element has a switch control terminal connected to the corresponding control port. One of the branches has a third resistance element. The other branch has a fourth resistance element and a third switch element series-connected with each other. The third switch element has a third control terminal connected to the charging circuit.

### BACKGROUND OF THE INVENTION

1. Field of the Invention

The present invention generally relates to a charging control circuit, and more particularly to a charging control circuit capable of effectively charging a plurality of rechargeable battery units of a pile formed by the series-connection of the battery units.

2. The Related Art

A charging control circuit used to charge a rechargeable battery often has a protecting function for preventing the battery from being overcharged and over-discharged. That is to say, in the process of charging the battery, when the voltage of the battery is raised to a predefined data (namely a protecting voltage for preventing the battery from being overcharged), the charging control circuit cuts off a protecting switch so as to terminate the charging process; in the process of discharging the battery, when the voltage of the battery goes down to another predefined data (namely another protecting voltage for preventing the battery from being over-discharged), the charging control circuit cuts off the protecting switch so as to terminate the discharging process. Therefore the battery can be protected from being damaged on account of the overcharging and over-discharging.

However, when the above-mentioned charging control circuit is used to charge a pile formed by the series-connection of a plurality of rechargeable battery units, if the remained power in each battery unit differs from each other, then the battery unit having a more remained power therein will be charged to easily make the voltage thereof raised to the predefined data firstly. At this time, the charging control circuit will cut off the protecting switch so as to protect the corresponding battery unit from being overcharged (namely the charging control circuit is disconnected) that prevents the charging control circuit from charging other battery units of the pile. Therefore, when the process of charging the pile is terminated, some battery units of the pile are not charged completely to be raised to the predefined data that reduces the time of supplying power of the pile.

### SUMMARY OF THE INVENTION

An object of the present invention is to provide a charging control circuit which is connected with a charging power supply for charging a pile formed by a series-connection of a plurality of battery units. The charging control circuit includes a protecting circuit, a charging circuit and a control circuit. The protecting circuit has a plurality of monitoring ports and control ports. The monitoring ports are connected with two terminals of the corresponding battery units for monitoring the voltage of the battery units. The charging circuit includes a plurality of diffluent circuits respectively parallel-connected to the corresponding battery units. Each diffluent circuit has a controlled switch element and a diffluent resistance element connected with each other in series. The controlled switch element has a switch control terminal connected to the respective control port of the protecting circuit. The control circuit includes two parallel branches connected between the charging power supply and the pile. One of the two branches has a third resistance element. The other branch has a fourth resistance element and a third switch element connected with each other in series. The third switch element has a third control terminal connected to the charging circuit. Wherein the protecting circuit controls a switch state of the controlled switch element of the charging circuit according to the voltage of the respective battery unit, the charging circuit controls connection or disconnection of the third switch element according to the switch state of the controlled switch element. So the charging current of the charging control circuit can be regulated to ensure each battery unit of the pile charged completely and efficiently.

### BRIEF DESCRIPTION OF THE DRAWINGS

The present invention will be apparent to those skilled in the art by reading the following description of a preferred embodiment thereof, with reference to the attached drawings, in which:

FIG. 1 is a circuitry of a charging control circuit according to the present invention.

### DETAILED DESCRIPTION OF THE PREFERRED EMBODIMENT

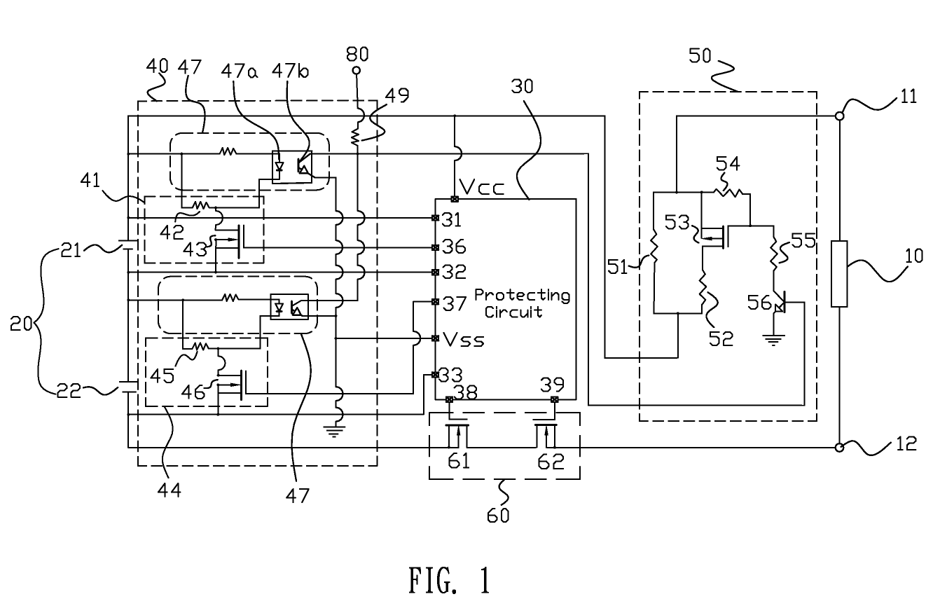

With reference to FIG. 1, a charging control circuit according to the present invention is shown. The charging control circuit is connected with a charging power supply 10 for charging a pile 20 formed by the series-connection of a plurality of rechargeable battery units. In this embodiment, the pile 20 is formed by the series-connection of a first battery unit 21 and a second battery unit 22. The charging power supply 10 has a positive terminal 11 and a negative terminal 12. The charging control circuit includes a protecting circuit 30, a charging circuit 40 and a control circuit 50. The anode of the first battery unit 21 is connected to the positive terminal 11 of the charging power supply 10 via the control circuit 50, and the cathode of the second battery unit 22 is connected to the negative terminal 12 of the charging power supply 10 via a protecting switch assembly 60 which will be described in detail later on.

The protecting circuit 30 is a chip, such as an OZ890 type of chip, having a protecting, monitoring and control function. A Vcc port of the protecting circuit 30 is connected with the anode of the first battery unit 21 for supplying a working voltage to the protecting circuit 30 and a Vss port thereof is connected to ground. The protecting circuit 30 has a plurality of monitoring ports and control ports. In the embodiment, the monitoring ports include a first monitoring port 31, a second monitoring port 32 and a third monitoring port 33; the control ports include a first control port 36, a second control port 37, a third control port 38 and a fourth control port 39. The anode of the first battery unit 21 is connected to the first monitoring port 31 and the cathode thereof is connected to the second monitoring port 32. The anode of the second battery unit 22 is connected to the second monitoring port 32 and the cathode thereof is connected to the third monitoring port 33. So the voltage of the first battery unit 21 and the second battery unit 22 can be monitored by the protecting circuit 30.

The charging circuit 40 includes a first diffluent circuit 41 and a second diffluent circuit 44. The first diffluent circuit 41 has a first resistance element 42 and a first switch element 43. The second diffluent circuit 44 has a second resistance element 45 and a second switch element 46. In the embodiment, the switch elements 43, 46 are an N-channel FET respectively. One terminal of the first resistance element 42 is connected with the anode of the first battery unit 21 and the other terminal thereof is connected with the drain of the first switch element 43. The source of the first switch element 43 is connected with the cathode of the first battery unit 21 and the grid thereof is connected to the first control port 36 of the protecting circuit 30, so the connection and the disconnection of the first switch element 43 are controlled by the first control port 36. One terminal of the second resistance element 45 is connected with the anode of the second battery unit 22 and the other terminal thereof is connected with the drain of the second switch element 46. The source of the second switch element 46 is connected with the cathode of the second battery unit 22 and the grid thereof is connected to the second control port 33 of the protecting circuit 30, so the connection and the disconnection of the second switch element 46 are controlled by the second control port 37.

The charging circuit 40 further includes two photo-couplers 47 each having a light-emitting diode (LED) 47a and a photosensitive triode 47b. The positive electrode of one of the two LEDs 47a is connected with the anode of the first battery unit 21 and the negative electrode thereof is connected with the drain of the first switch element 43. The positive electrode of the other LED 47a is connected with the anode of the second battery unit 22 and the negative electrode thereof is connected with the drain of the second switch element 46. The collector of each of the photosensitive triodes 47b is connected to a regulated power supply 80 via a first voltage-dividing resistance 49 for supplying a working voltage to the corresponding photosensitive triode 47b. The emitter of each of the photosensitive triodes 47b is connected to ground. The connection and the disconnection of the photosensitive triode 47b are controlled by the corresponding LED 47a.

The control circuit 50 has two branches. One of the two branches includes a third resistance element 51 having one terminal connected with the positive terminal 11 and the other terminal connected with the anode of the first battery unit 21. The other branch includes a fourth resistance element 52 and a third switch element 53. In the embodiment, the third switch element 53 is a P-channel FET. The source of the third switch element 53 is connected with the positive terminal 11 and the drain thereof is connected with one terminal of the fourth resistance element 52. The other terminal of the fourth resistance element 52 is connected with the anode of the first battery unit 21. The grid of the third switch element 53 is connected to the positive terminal 11 via a second voltage-dividing resistance 54 on one hand, and on the other hand connected to ground via a third voltage-dividing resistance 55 and a control switch 56. In the embodiment, the control switch 56 is a NPN triode. One terminal of the third voltage-dividing resistance 55 is connected with the grid of the third switch element 53 and the other terminal thereof is connected with the collector of the control switch 56. The emitter of the control switch 56 is connected to ground and the base thereof is connected with the collector of each of the photosensitive triodes 47b of the charging circuit 40. So the photo-couplers 47 can control the connection and the disconnection of the control switch 56 for further controlling the connection and the disconnection of the third switch element 53.

The protecting switch assembly 60 includes a first protecting switch 61 preventing the pile 20 from being over-discharged and a second protecting switch 62 preventing the pile 20 from being overcharged. In the embodiment, the protecting switches 61, 62 are respectively an N-channel FET. The drain of the first protecting switch 61 is connected with the drain of the second protecting switch 62. The source of the first protecting switch 61 is connected with the cathode of the second battery unit 22, and the source of the second protecting switch 62 is connected with the negative terminal 12. The grid of the first protecting switch 61 is connected to the third control port 38 of the protecting circuit 30, and the grid of the second protecting switch 62 is connected to the fourth control port 39. So the connection and the disconnection of the protecting switches 61, 62 are controlled by the protecting circuit 30 so as to protect the pile 20 from being damaged on account of the over-discharging and overcharging.

The process of utilizing the above-mentioned charging control circuit to charge the pile 20 is described as follows.

In the process of charging the pile 20, when the voltage difference between the first battery unit 21 and the second battery unit 22 is monitored by the protecting circuit 30 to be smaller than a specific data (such as 0.02˜0.01V), the first switch element 43 and the second switch element 46 are respectively disconnected by the first control port 36 and the second control port 37 of the protecting circuit 30. At this time, the photo-couplers 47 are disconnected, the regulated power supply 80 supplies a voltage to the base of the control switch 56 so as to make the positive terminal 11, the second voltage-dividing resistance 54, the third voltage-dividing resistance 55, the control switch 56 and ground to form a circuit. As a result, the potential of the source of the third switch element 53 is higher than the potential of the grid thereof that makes the third switch element 53 connected. So the total resistance is reduced and the charging current is increased because of the parallel-connection of the third resistance element 51 and the fourth resistance element 52 that improves the charging efficiency to the pile 20.

When the voltage difference between the first battery unit 21 and the second battery unit 22 is monitored by the protecting circuit 30 to be greater than the said specific data, the first switch element 43 is connected by the first control port 36 of the protecting circuit 30 if the first battery unit 21 has a higher voltage, on the contrary, the second switch element 46 is connected by the second control port 37 if the second battery unit 22 has a higher voltage. Now take description to the working principle of the charging control circuit provided that the first battery unit 21 has a higher voltage. When the voltage of the first battery unit 21 is higher, the first switch element 43 is connected by the first control port 36 of the protecting circuit 30 so as to make the charging current divided by the first resistance element 42 and reduce the charging current to the first battery unit 21. Simultaneously, the LED 47a emits light to make the corresponding photosensitive triode 47b connected. So the regulated power supply 80, the first voltage-dividing resistance 49, the corresponding photosensitive triode 47b and ground form a circuit for disconnecting the control switch 56. As a result, the connection of the positive terminal 11, the second voltage-dividing resistance 54, the third voltage-dividing resistance 55, the control switch 56 and ground is disconnected that makes the third switch element 53 disconnected. At this time, the charging power supply 10 charges the pile 20 only through the third resistance element 51 that makes the total resistance increased and the charging current reduced. Moreover the first resistance element 42 has a current-dividing function to the charging current that further reduces the charging current to the first battery unit 21. Thereby the charging current is greater in the second battery unit 22 than in the first battery unit 21 that ensures the second battery unit 22 charged efficiently until the voltage difference between the first battery unit 21 and the second battery unit 22 is smaller than the said specific data.

When the voltage of the first battery unit 21 or the second battery unit 22 is monitored by the protecting circuit 30 to be raised to a predefined data (namely a protecting voltage for preventing the pile 20 from being overcharged), the second protecting switch 62 is disconnected by the fourth control port 39 of the protecting circuit 30 so as to terminate the process of charging the pile 20. In the process of discharging the pile 20, when the voltage of the first battery unit 21 or the second battery unit 22 is monitored by the protecting circuit 30 to go down to a predefined data (namely a protecting voltage for preventing the pile 20 from being over-discharged), the first protecting switch 61 is disconnected by the third control port 38 so as to terminate the process of discharging the pile 20. Therefore the pile 20 can be protected from being damaged on account of the overcharging and over-discharging.

As described above, the charging control circuit of the present invention utilizes the protecting circuit 30 to control a switch state of the first switch element 43 and the second switch element 46 of the charging circuit 40 according to the voltage difference between the first battery unit 21 and the second battery unit 22, and then utilizes the photo-coupler 47 of the charging circuit 40 to control connection or disconnection of the third switch element 53 of the control circuit 50 according to the said switch state so as to regulate the charging current for ensuring the first battery unit 21 and the second battery unit 22 be charged completely and efficiently.

What is claimed is:

1. A charging control circuit connected with a charging power supply for charging a pile formed by a series-connection of a plurality of battery units, comprising:
a protecting circuit having a plurality of monitoring ports and control ports, the monitoring ports being connected with two terminals of the corresponding battery units for monitoring the voltage of the battery units;
a charging circuit including a plurality of diffluent circuits respectively parallel-connected to the corresponding battery units, each diffluent circuit having a controlled switch element and a diffluent resistance element connected with each other in series, the controlled switch element having a switch control terminal connected to the respective control port of the protecting circuit; and
a control circuit including two parallel branches connected between the charging power supply and the pile, one of the two branches having a third resistance element, the other branch having a fourth resistance element and a third switch element connected with each other in series, the third switch element having a third control terminal connected to the charging circuit;
wherein the protecting circuit controls a switch state of the controlled switch element of the charging circuit according to the voltage of the respective battery unit, the charging circuit controls connection or disconnection of the third switch element according to the switch state of the controlled switch element.

2. The charging control circuit as claimed in claim 1, wherein the charging circuit further includes a plurality of photo-couplers each having a light-emitting diode and a photosensitive triode, the light-emitting diode is parallel-connected to the respective diffluent resistance element, an emitter of the photosensitive triode is connected to ground and a collector thereof is connected with a regulated power supply through a first voltage-dividing resistance, the collector of the photosensitive triode is moreover connected to the third control terminal of the third switch element of the control circuit through a control switch and a third voltage-dividing resistance.

3. The charging control circuit as claimed in claim 2, wherein the control switch is a NPN triode having a collector connected with the third control terminal of the third switch terminal through the third voltage-dividing resistance and an emitter connected to ground, a base of the NPN triode is connected with the collector of each photosensitive triode of the charging circuit, the third control terminal of the third switch element is further connected with the charging power supply through a second voltage-dividing resistance.

4. The charging control circuit as claimed in claim 1, further comprising two protecting switches series-connected between the pile and the charging power supply, each protecting switch being further connected to the respective control port of the protecting circuit for being controlled to be connected or disconnected.

5. The charging control circuit as claimed in claim 4, wherein each of the protecting switches is a field effect transistor, two drains of the field effect transistors are connected with each other, two sources thereof are respectively connected to the charging power supply and the pile, and two grids thereof are respectively connected to the corresponding control ports of the protecting circuit.
